(19) United States
(12) Patent Application Publication
(10) Pub. No.: US 2016/0365162 A1
(43) Pub. Date: Dec. 15, 2016

(54) SYSTEM TO CONTROL ASSET DECOMMISSIONING AND RECONCILE CONSTRAINTS

(71) Applicant: General Electric Company, Schenectady, NY (US)

(72) Inventors: Christopher Donald Johnson, Niskayuna, NY (US); Brian Nathan Dingman, Gloversville, NY (US); Ilkin Onur Dulgeroglu, Niskayuna, NY (US); David Joseph Brewer, Wilmington, NC (US); Gregg Allen Schneider, Wilmington, NC (US); Eric Russell Mino, Wilmington, NC (US)

(21) Appl. No.: 14/738,404

(22) Filed: Jun. 12, 2015

(51) Int. Cl. G21D 1/00; G06Q 10/06

(52) U.S. Cl. CPC G21D 1/003; G06Q 10/0637

(57) ABSTRACT

Aspects of the present disclosure involve a system comprising a computer-readable storage medium storing at least one program, and a method for generating optimal power plant decommissioning plans based on stakeholder constraints. In example embodiments, the method may include receiving one or more constraints for determining a power plant decommissioning plan. The method further includes accessing decommissioning strategy data representing a plurality of possible decommissioning plans, and generating a decommissioning plan in accordance with the constraints based on the decommissioning strategy data. The method may further include causing presentation of a user interface on a client device that includes a graphical representation of the power plant decommissioning plan.

### TECHNICAL FIELD

The subject matter disclosed herein relates to power plants. In particular, example embodiments relate to computer-implemented techniques for monitoring and controlling decommissioning of a power plant.

### BACKGROUND

In order to permanently close a power plant facility, the facility must be decommissioned to safely remove it from service. The process of decommissioning a power plant involves decontaminating the facility to reduce residual radioactivity to permissible levels, dismantling the structures at the facility, removing contaminated materials, and releasing the property for other uses. The Nuclear Regulatory Commission (NRC) has established a strict set of regulations and associated guidance that outline the requirements and process for decommissioning a power plant. For example, the NRC requires power plant owners to set aside and maintain decommissioning funds throughout the power plant's operational lifetime to fund the eventual decommissioning. Another requirement established by the NRC is that every power plant must routinely submit a decommissioning plan outlining the steps for successfully decommissioning the power plant along with an analysis of financial considerations during the decommissioning (e.g., whether the decommissioning funds are enough to successfully decommission the power plant).

Traditional power plant decommissioning financial analysis is based on antiquated models that include basic assumptions for deterministically calculating costs associated with decommissioning a power plant. However, the models use generic assumptions that are based on a single power plant style that are then extrapolated for different power plant styles. Further, the assumptions of the models are based on outdated information and reference plants so they do not take into consideration the real life scenarios of today. As a result, analysis under the models may not provide sufficient detail or analysis to lead to a successful power plant decommissioning in terms of budget because most power plants overspend their anticipated decommissioning budget, oftentimes spending hundreds of millions of dollars more than anticipated.

### BRIEF DESCRIPTION OF THE DRAWINGS

Various ones of the appended drawings merely illustrate example embodiments of the present inventive subject matter and cannot be considered as limiting its scope.

FIG. 1 is a block diagram illustrating various functional components of a decommissioning simulation and optimization application, according to some example embodiments.

FIG. 2 is a diagrammatic representation of a machine in the example form of a computer system within which a set of instructions for causing the machine to perform any one or more of the methodologies discussed herein may be executed.

FIG. 3 is a data flow diagram illustrating a method for simulating a power plant decommissioning plan, according to some example embodiments.

FIG. 4 is a graph illustrating an example simulation of cash flows associated with a power plant decommissioning plan, according to some example embodiments.

FIG. 5 is a data flow diagram illustrating a method for determining an optimal power plant decommissioning plan, according to some example embodiments.

FIG. 6 is a diagram illustrating example decommissioning strategy data including a decision tree representing possible power plant decommissioning plans, according to some example embodiments.

FIG. 7 is a data flow diagram illustrating a method for optimizing an existing power plant decommissioning plan, according to some example embodiments.

FIG. 8 is a flow chart illustrating a method for determining viability of an existing power plant decommissioning plan, according to some example embodiments.

FIG. 9 is a flow chart illustrating a method for determining an economic return associated with a power plant decommissioning plan, according to some example embodiments.

FIG. 10 is a flow chart illustrating a method for determining an optimal power plant decommissioning plan based on stakeholder constraints, according to some example embodiments.

FIG. 11 is a flow chart illustrating a method for selecting an optimal path in a decision tree representing a plurality of decommissioning plans, according to some example embodiments.

FIG. 12 is a flow chart illustrating a method for optimizing an existing decommissioning plan, according to some example embodiments.

FIG. 13 is a graph illustrating a process of automatically reconciling decommissioning timing and cost constraints with dynamical control of prior outage work scopes, according to example embodiments.

FIG. 14 is a flow chart illustrating a method for determining an optimal power plant decommissioning plan based on stakeholder constraints, according to some example embodiments.

### DETAILED DESCRIPTION

Reference will now be made in detail to specific example embodiments for carrying out the inventive subject matter. Examples of these specific embodiments are illustrated in the accompanying drawings, and specific details are set forth in the following description in order to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

Aspects of the present disclosure involve simulating and optimizing power plant decommissioning plans. For purposes of the present disclosure, “decommissioning” refers to a process for permanently removing a power plant facility from service including dismantling all structures of the facility and reducing on-site radioactive materials to levels permitted by pertinent regulation. Accordingly, a power plant decommissioning plan includes a series of scheduled activities (e.g., tasks) involved in decommissioning a power plant. Example embodiments include systems and methods to simulate existing power plant decommissioning plans to determine the viability thereof. Such a method may include accessing data representing an existing decommissioning plan for a power plant and data representing financial information associated with a power plant. The method may further include simulating various cash flows associated with the power plant's decommissioning plan using probabilistic model developed using historical power plant information. The simulated cash flows are then used to determine a probability that the existing decommissioning plan will result in at least a threshold return (e.g., economic return). Information related to the simulated cash flows and the probability of achieving the threshold return may be displayed in one or more user interfaces presented on a user device.

Additional example embodiments include systems and methods to generate optimal power plant decommissioning plans based on stakeholder constraints. Such a method may include receiving a user request for an optimal decommissioning plan along with constraints for determining the optimal decommissioning plan. The method may further include simulating outcomes (e.g., resulting economic return) of possible decommissioning plans, and identifying possible decommissioning plans that satisfy the constraints based on the simulated outcomes. An optimal decommissioning plan may then be selected from the identified possible decommissioning plans that satisfy the constraints based on the simulated outcomes. The selected decommissioning plan is “optimal” in the sense that it is the most favorable of the decommissioning plans that satisfy the constraints. Information related to the optimal decommissioning plan as well as the other possible decommissioning plans may then be displayed in one or more user interfaces presented on a user device.

Further example embodiments include systems and methods to optimize existing power plant decommissioning plans in accordance with stakeholder constraints. Such a method may include receiving data representing an existing decommissioning plan along with constraints for optimizing the existing decommissioning plans. The method may further include simulating possible outcomes of the existing decommissioning plan given the current status of the plan, and using the simulated outcomes to determine optimal values for flexible decision variables. The flexible decision variables include factors that impact the outcome of the decommissioning plan that are not otherwise constrained by the constraints. For example, the flexible decision variables may include start dates or durations for certain activities associated with decommissioning a power plant. The method further includes generating and transmitting updated data representing the existing decommissioning plan with the optimal values for the flexible decision variables to a user device.

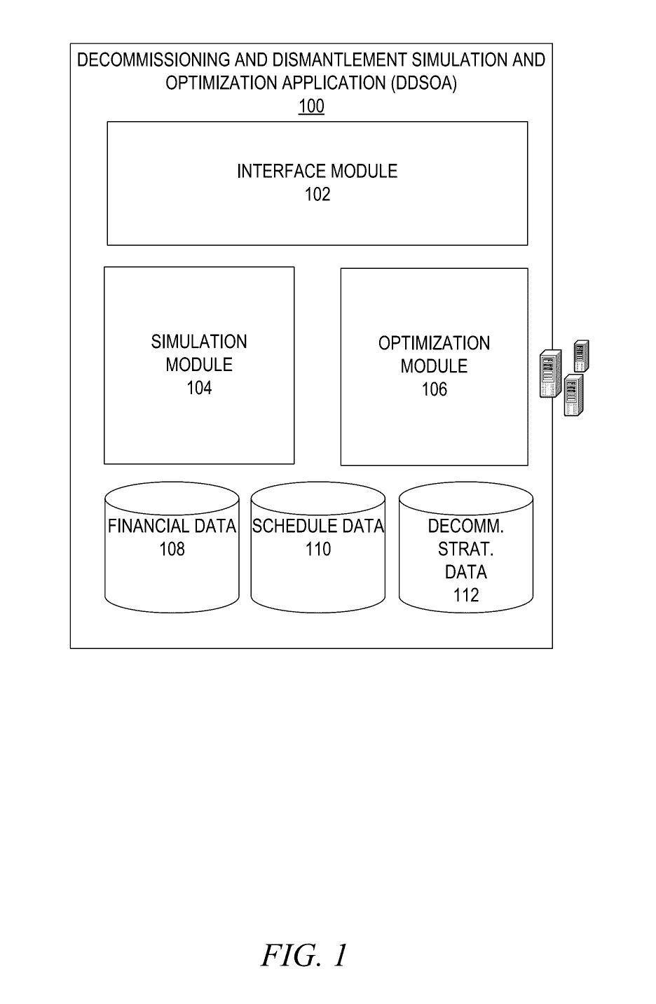

FIG. 1 is a block diagram illustrating various functional components of a decommissioning and dismantlement simulation and optimization application (DDSOA) 100, consistent with some embodiments. To avoid obscuring the inventive subject matter with unnecessary detail, various functional components (e.g., modules and engines) that are not germane to conveying an understanding of the inventive subject matter have been omitted from FIG. 1. However, a skilled artisan will readily recognize that various additional functional components may be supported by the DDSOA 100 to facilitate additional functionality that is not specifically described herein. Moreover, it shall be appreciated that while the functional components (e.g., modules and engines) of FIG. 1 are discussed in the singular sense, in other embodiments, multiple instances of one or more of the modules may be employed.

As illustrated in FIG. 1, the DDSOA 100 includes an interface module 102, simulation module 104, and an optimization module 106, all configured to be in communication with each other (e.g., via a bus, a shared memory, a network, or a switch) so as to allow information to be passed between the functional components or so as to allow the functional components to share and access common data.

As shown, the DDSOA 100 is generally based on three-layer software architecture, consisting of a front-end layer, a logic layer, and a data layer, although the inventive subject matter is by no means limited to such architecture. The presentation layer consists of the interface module 102 that is responsible for presenting information and handling user interactions related to functions and services provided by the DDSOA 100. Accordingly, the interface module 102 may provide a number of interfaces (e.g., by causing the interfaces to be presented on a display of a computing system) to users (e.g., power plant stakeholders) that allow such users to request simulation of existing power plant decommissioning plans, generation of optimal power plant decommissioning plans, or optimization of existing power plant decommissioning plans. To this end, interfaces provided by the interface module 102 may include graphical interface elements (e.g., buttons, toggles, switches, drop-down menus, or sliders) that may be manipulated through user input to perform various operations associated with simulating and optimizing power plant decommissioning plans. For example, the interface module 102 may provide an interface element (e.g., text entry field or drop-down menu) that allows users to input constraints for determining an optimal power plant decommissioning plan. The interface module 102 also receives and processes user input received through such interface elements.

The application layer of the DDSOA 100 includes the simulation module 104 and the optimization module 106. The simulation module 104 is configured to simulate cash flows of a power plant over the operational lifetime of the power plant. These cash flows include costs associated with decommissioning the power plant, costs associated with operating the power plant, operational revenue, and revenue generated from investments (e.g., decommissioning funds). In some embodiments, the simulation module 104 simulates the cash flows of the power plant to provide information to stakeholders regarding the probability that a particular decommissioning plan will result in at least a threshold return value (e.g., no surplus and no deficit). In other words, the cash flows of the power plant are simulated to provide stakeholders with an indication of the viability of an existing decommissioning plan. In simulating the cash flows of the power plant, the simulation module 104 uses a probabilistic model that estimates, on the basis of historical data, the probability of a decommissioning plan producing certain return values. In this manner, the simulation module 104 produces probability distributions that represent the relationships of values corresponding to risks and returns associated with decommissioning plans. From these probability distributions, the probability that the decommissioning plan will result in at least a threshold return value may be ascertained.

The optimization module 106 is configured to generate new decommissioning plans that are optimized in accordance with user constraints. The user constraints may, for example, include a threshold value for risk, a threshold value for return, a specific start date for decommissioning, a start date for a particular activity, an end date for decommissioning, or a time period for decommissioning. The optimization module 106 generates these optimal decommissioning plans based on an analysis of all possible decommissioning plans for a given decommissioning strategy. In performing the analysis of all possible decommissioning plans, the optimization module 106 works in conjunction with the simulation module 104 to simulate the cash flows associated with each possible decommissioning plan. Based on the simulated cash flows of each possible decommissioning plan, the optimization module 106 selects a decommissioning plan that satisfies the user constraints.

The optimization module 106 is also configured to optimize ongoing decommissioning plans based on the current status of the decommissioning plan and constraints (e.g., regulatory constraints, a threshold risk value, a threshold return value, a start date for certain activities, a decommissioning end date, or a decommissioning time horizon). In particular, the optimization module 106 may be used to determine optimal values for certain variables associated with the ongoing decommissioning plan that are flexible (e.g., start dates or durations corresponding to activities associated with decommissioning a power plant). These flexible variables may include items that the user has not provided as a constraint. In optimizing existing decommissioning plans, the optimization module 106 determines the current status of the decommissioning plan and identifies a node in the decision tree that corresponds to the current status. The optimization module 106 then works in conjunction with the simulation module 104 to determine predicted cash flows associated with all possible future alternatives to the decommissioning plan for a variety of different variables that impact the eventual return, such as a starting date for activities associated with decommissioning, time periods over which the decommissioning occurs, inflation rates, and growth rates, among others. The optimization module 106 may then compare the cash flows associated with different variable values (e.g., different starting dates or durations for activities or different orders of activities) to determine the optimal values in terms of user constraints.

The data layer of the DDSOA 100 includes financial data 108, schedule data 110, and decommissioning strategy data 112. The data layer may reside on one or more external or internal databases that may be accessed via a network (e.g., through interaction with appropriate database servers). The financial data 108 includes information related to power plant finances such as amounts of value in financial accounts associated with the power plant. For example, the financial accounts include an investment pool of funds set aside for decommissioning (referred to as “decommissioning funds”). The financial accounts may also include other accounts in which the stakeholders of the power plant maintain funds derived from or associated with the power plant. The financial data 108 may be obtained, via a network, from one or more third-party computing systems corresponding to financial institutions that maintain the accounts. The financial data 108 may be updated on a routine basis so as to ensure that all calculations that depend on such information are also up-to-date.

The schedule data 110 includes information related to decommissioning plans. In particular, in instances in which a power plant has an existing decommissioning plan, the schedule data 110 includes a series of activities related to decommissioning a power plant, and in this way, the schedule data 110 represents the decommissioning plan. In some embodiments, the schedule data 110 is retrieved from a networked database of the power plant. In some embodiments, the schedule data 110 is provided by a user and uploaded from a client device operated by the user. The schedule data 110 may, for example, correspond to a Primavera P6 or Microsoft Project file.

The decommissioning strategy data 112 includes a decision tree for each possible decommissioning strategy that may be used to decommission a power plant. Each respective decision tree included in the decommissioning strategy data 112 includes data representing a tree-like graph of power plant activities and their possible outcomes, which may be other power plant activities. More specifically, the decision tree includes a plurality of nodes and a plurality of branches connecting the nodes. Each node represents an activity, and each branch represents an outcome of an activity. Some activities include a decision that dictates the next activity, thus resulting in the creation of different “paths” in the decision tree. Each path in the decision tree connects a root node (e.g., the initial node in the tree) to an end node (e.g., a node with no outgoing branches). Each path in the decision tree represents a possible decommissioning plan.

As is understood by skilled artisans in the relevant computer arts, the modules and engines illustrated in FIG. 1 represent a set of executable software instructions and the corresponding hardware (e.g., memory and processor) for executing the instructions. Furthermore, the various functional components depicted in FIG. 1 may reside on a single machine (e.g., computer system), or may be distributed across several machines in various arrangements such as cloud-based architectures.

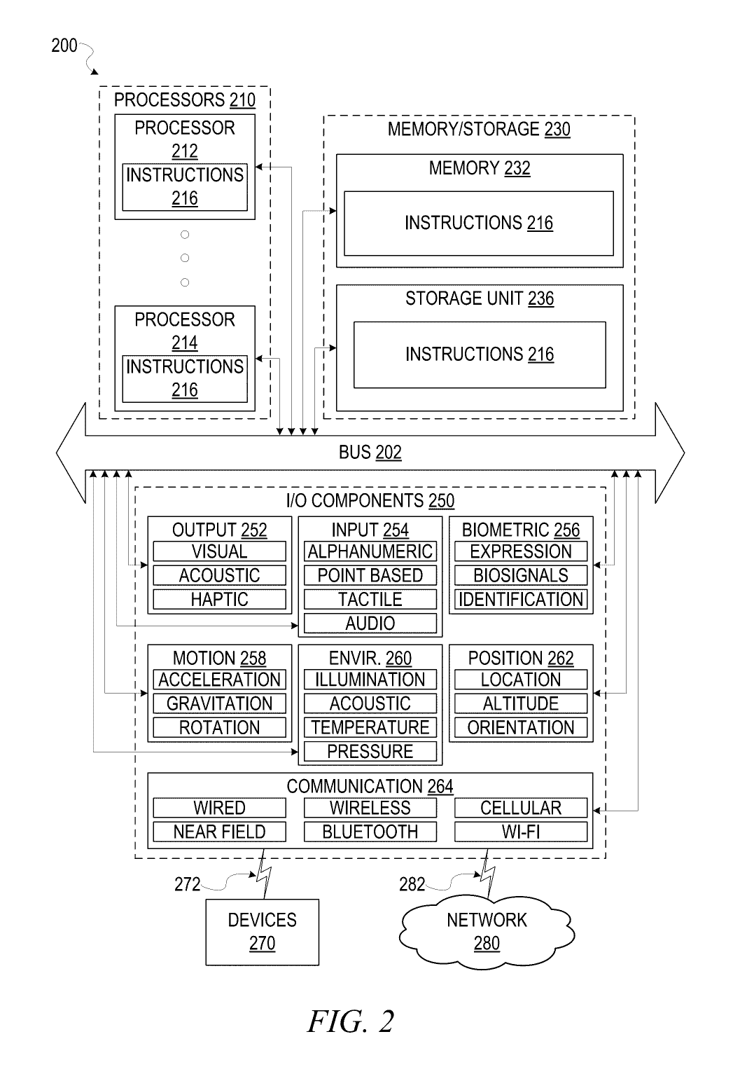

As an example of such a machine, FIG. 2 is a block diagram illustrating components of a machine 200, according to some embodiments, able to read instructions from a machine-readable medium (e.g., a machine-readable storage medium) and perform any one or more of the methodologies discussed herein. Specifically, FIG. 2 shows a diagrammatic representation of the machine 200 in the example form of a computer system, within which instructions 216 (e.g., software, a program, an application, an applet, an app, or other executable code) for causing the machine 200 to perform any one or more of the methodologies discussed herein may be executed. For example, the instructions 216 include executable code that cause the machine 200 to execute the DDSOA 100 and the associated functionalities described herein. These instructions transform the general, non-programmed machine into a particular machine programmed to carry out the described and illustrated functions of the DDSOA 100 in the manner described herein. The machine 200 may operate as a standalone device or may be coupled (e.g., networked) to other machines. In a networked deployment, the machine 200 may operate in the capacity of a server machine or a client machine in a server-client network environment, or as a peer machine in a peer-to-peer (or distributed) network environment. By way of non-limiting example, the machine 200 may comprise or correspond to a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 216, sequentially or otherwise, that specify actions to be taken by machine 200. Further, while only a single machine 200 is illustrated, the term “machine” shall also be taken to include a collection of machines 200 that individually or jointly execute the instructions 216 to perform any one or more of the methodologies discussed herein.

The machine 200 may include processors 210, memory/storage 230, and input/output (I/O) components 250, which may be configured to communicate with each other such as via a bus 202. In an example embodiment, the processors 210 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 212 and processor 214 that may execute instructions 216. The term “processor” is intended to include multi-core processor that may comprise two or more independent processors (sometimes referred to as “cores”) that may execute instructions contemporaneously. Although FIG. 2 shows multiple processors 210, the machine 200 may include a single processor with a single core, a single processor with multiple cores (e.g., a multi-core process), multiple processors with a single core, multiple processors with multiples cores, or any combination thereof.

The memory/storage 230 may include a memory 232, such as a main memory, or other memory storage, and a storage unit 236, both accessible to the processors 210 such as via the bus 202. The storage unit 236 and memory 232 store the instructions 216 embodying any one or more of the methodologies or functions described herein. The storage unit 236 may also store the financial data 108, the schedule data 110, and the decommissioning strategy data 112. The instructions 216 may also reside, completely or partially, within the memory 232, within the storage unit 236, within at least one of the processors 210 (e.g., within the processor's cache memory), or any suitable combination thereof, during execution thereof by the machine 200. Accordingly, the memory 232, the storage unit 236, and the memory of processors 210 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 216. The term “machine-readable medium” shall also be taken to include any medium, or combination of multiple media, that is capable of storing instructions (e.g., instructions 216) for execution by a machine (e.g., machine 200), such that the instructions, when executed by one or more processors of the machine 200 (e.g., processors 210), cause the machine 200 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 250 may include a wide variety of components to receive input, provide output, produce output, transmit information, exchange information, capture measurements, and so on. The specific I/O components 250 that are included in a particular machine will depend on the type of machine. For example, portable machines such as mobile phones will likely include a touch input device or other such input mechanisms, while a headless server machine will likely not include such a touch input device. It will be appreciated that the I/O components 250 may include many other components that are not shown in FIG. 2. The I/O components 250 are grouped according to functionality merely for simplifying the following discussion and the grouping is in no way limiting. In various example embodiments, the I/O components 250 may include output components 252 and input components 254. The output components 252 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 254 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 250 may include biometric components 256, motion components 258, environmental components 260, or position components 262 among a wide array of other components. For example, the biometric components 256 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 258 may include acceleration sensor components (e.g., accelerometer), gravitation sensor components, rotation sensor components (e.g., gyroscope), and so forth. The environmental components 260 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 262 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 250 may include communication components 264 operable to couple the machine 200 to a network 280 or devices 270 via coupling 282 and coupling 272, respectively. For example, the communication components 264 may include a network interface component or other suitable device to interface with the network 280. In further examples, communication components 264 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 270 may be another machine or any of a wide variety of peripheral devices (e.g., a peripheral device coupled via a Universal Serial Bus (USB)).

Moreover, the communication components 264 may detect identifiers or include components operable to detect identifiers. For example, the communication components 264 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 264, such as location via Internet Protocol (IP) geo-location, location via Wi-Fi® signal triangulation, location via detecting an NFC beacon signal that may indicate a particular location, and so forth.

In various example embodiments, one or more portions of the network 280 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 280 or a portion of the network 280 may include a wireless or cellular network and the coupling 282 may be a Code Division Multiple Access (CDMA) connection, a Global System for Mobile communications (GSM) connection, or other type of cellular or wireless coupling. In this example, the coupling 282 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 216 may be transmitted or received over the network 280 using a transmission medium via a network interface device (e.g., a network interface component included in the communication components 264) and utilizing any one of a number of well-known transfer protocols (e.g., Hypertext Transfer Protocol (HTTP)). Similarly, the instructions 216 may be transmitted or received using a transmission medium via the coupling 272 (e.g., a peer-to-peer coupling) to devices 270. The term “transmission medium” shall be taken to include any intangible medium that is capable of storing, encoding, or carrying instructions 216 for execution by the machine 200, and includes digital or analog communications signals or other intangible medium to facilitate communication of such software.

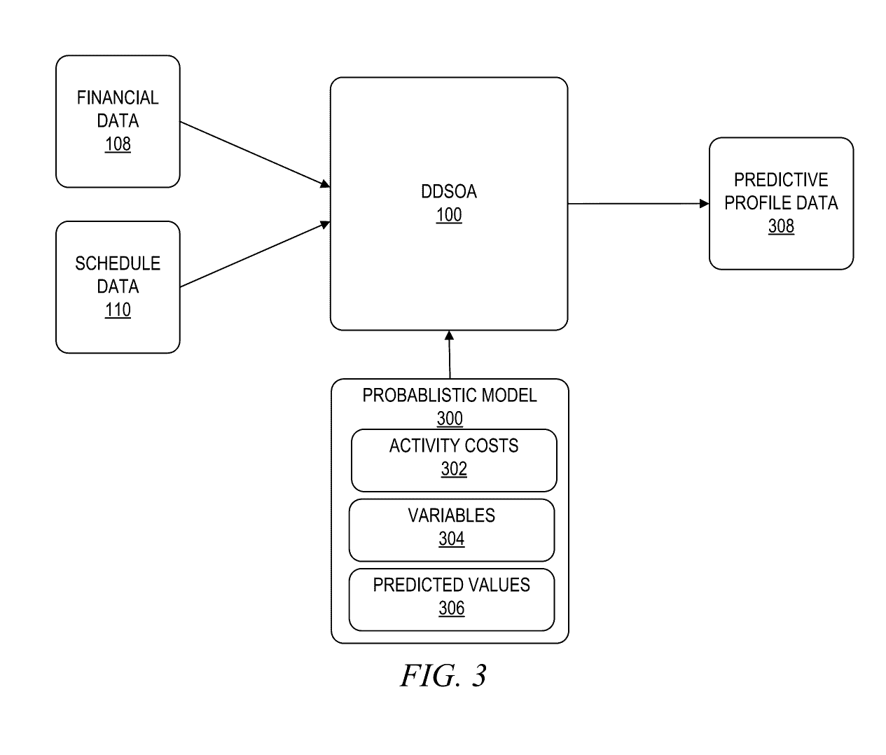

FIG. 3 is a data flow diagram illustrating a process of simulating a power plant decommissioning plan, according to some embodiments. As shown, the DDSOA 100 takes the financial data 108, and the schedule data 110 as inputs. The financial data 108 includes values corresponding to funds maintained in one or more financial accounts maintained by one or more financial institutions. The financial data 108 may be obtained from a user (e.g., via an interface provided by the interface module 102) or retrieved directly, via a network connection, from networked computing systems of the financial institutions that maintain the accounts. The schedule data 110 corresponds to a power plant decommissioning plan; accordingly, the schedule data 110 includes a series of activities forming the power plant decommissioning plan, a decommissioning start date, and a decommissioning end date. For each activity, the schedule data 110 includes an identifier of the activity, a scheduled date, and a duration.

As shown, as part of the process of simulating a the DDSOA 100 accesses and employs a probabilistic model 300 to estimate, on the basis of historical data, the probability of a decommissioning plan producing certain return values. Accordingly, the probabilistic model 300 includes a plurality of activity costs 302 that include costs associated with each possible activity. The plurality of activity costs 302 may be based on either historical costs associated with respective activities or values mandated by regulation, where applicable.

The probabilistic model 300 also includes a plurality of variables 304 and a range of predicted values 306 for each variable. The plurality of variables 304 correspond to factors that impact the return values associated with the power plant decommissioning plan. The plurality of variables 304 may, for example, include financial variables such as inflation rate, investment growth rate (e.g., interest rate), energy rate, and energy production rate among others. In some embodiments, the plurality of variables 304 also include temporal variables such as start dates and durations corresponding to activities associated with decommissioning a power plant (e.g., activities leading to the decommissioning and activities performed in furtherance of the decommissioning). The range of predicted values 306 may include values based on historical values associated with each variable and values mandated by regulation, where applicable.

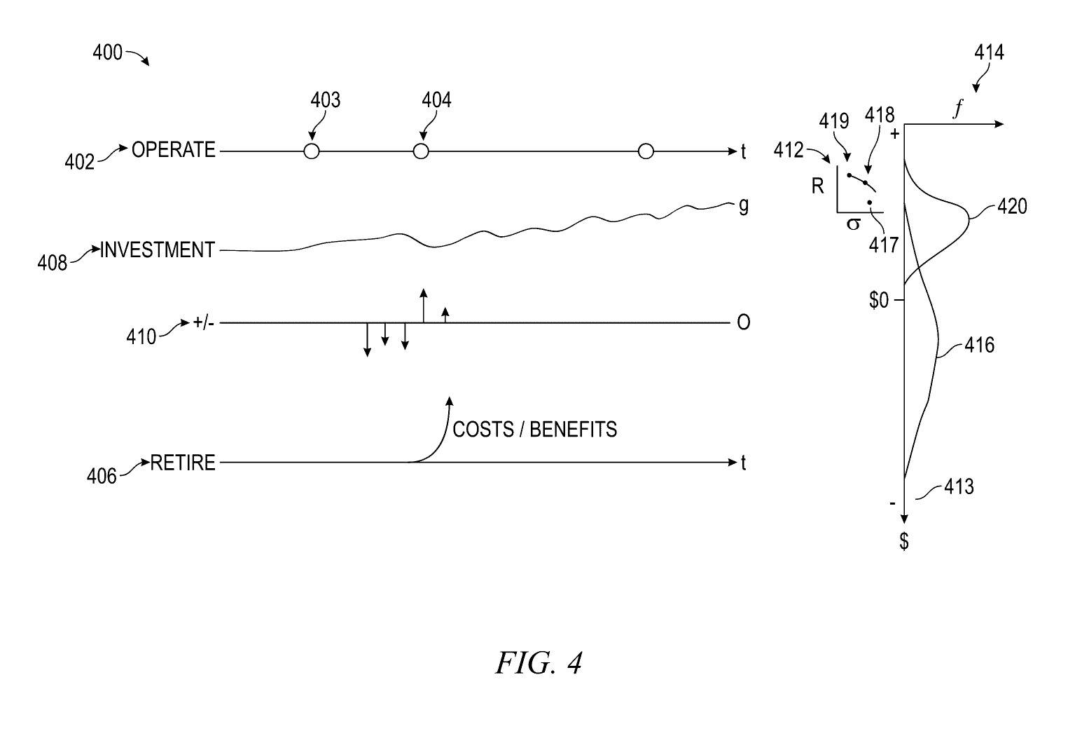

The DDSOA 100 uses the probabilistic model 300 to simulate cash flows of the power plant over the decommissioning time horizon, which is defined by the time period spanning the decommissioning start date and the decommissioning end date. More specifically, the simulation module 104 of the DDSOA 100 calculates costs associated with decommissioning the power plant, costs associated with operating the power plant, operational revenue, and revenue generated from investments (e.g., decommissioning funds) over the decommissioning time period. As an example of the foregoing simulation, FIG. 4 is a graph 400 illustrating an example simulation of cash flows associated with a power plant decommissioning plan, according to some embodiments.

As shown, the graph 400 includes operational cash flow 402 graphed over time, t, wherein t represents the decommissioning time horizon. Markers 403, 404, and 405 correspond to trigger points for beginning certain activities in the decommissioning plan. The operational cash flow 402 includes an aggregate of operational revenue and operational costs. The operational revenue depends on energy rate (e.g., a dollar amount per unit of electricity) and energy production rate (e.g., an amount of energy produced by the power plant over time). The operational costs depend at least in part on equipment costs (e.g., maintaining, repairing, and replacing equipment) and labor costs (e.g., costs of paying the power plant's workforce). Accordingly, the plurality of variables 304 of the probabilistic model 300 include energy rate, energy production rate, equipment cost, and labor cost, as well as a range of predicted values 306 for each of these variables. Each activity of the decommissioning plan also has associated costs (e.g., labor and equipment costs), and thus, the probabilistic model 300 also includes a plurality of activity costs 302 corresponding to costs associated with each possible activity. Additional costs associated with retiring the plant are represented by retirement costs 406.

The graph 400 further includes an investment value 408 graphed over the decommissioning time horizon. The investment value 408 corresponds to an amount of funds set aside by owners of the power plant in one or more accounts maintained by one or more financial institutions. As shown, over the time horizon, the investment value 408 increases at variable growth rates. Accordingly, the plurality of variables 304 of the probabilistic model 300 include a growth rate, as well as a range of predicted values 306 for the growth rate.

In simulating the cash flows of the power plant, the simulation module 104 compares the operational cash flow 402 with the investment value 408, which is represented by plus/minus line 410. Because the probabilistic model 300 includes a range of values 306 for each of the plurality of variables 304, the simulation of cash flows by the simulation module 104 results in a pareto frontier 412, where R represents return (e.g., surplus funds available at the end of decommissioning) and σ represents a variation in the set of return values, which corresponds to risk associated with the decommissioning plan.

In some embodiments, the return relationship between the accrued dismantlement reserves and the costs of dismantlement as well as the probabilities for such surplus to be within a targeted risk tolerance are criteria used in reconciling the decommissioning plan, timing, or work scope for an event period in advance of the decommissioning date and for the prosecution of the plant's dismantlement. The Pareto frontier 412 of scenarios produced by the simulation relates the surplus and the probability of a given surplus. Some embodiments involve automatically changing design specifications of outage work scopes, timing of the decommissioning, the physical sizing of apparatus, supply chain timing or quantity of specific assets so as to meet a risk and return constraint 417, the realization of which would be financially catastrophic. Feasibly reconciling this risk and return constraint 417 along the Pareto frontier 412 may be desirable, such as at point 418, however it may not be as optimal as doing so at point 419 where the maximum surplus is attained at the lowest risk. In some embodiments, achieving maximum financial vitality 419 is an input constraint while, though less conceivable, achieving some other relationship 418 of risk and return may be made possible. The variation represented as average variation 412 may not be precise or robust enough for a given risk tolerance, in which case, the full range of probabilities 414 are computed for comparison of vitalities.

FIG. 4 also depicts comparative vitalities of various automated control points. Values corresponding to financial surplus or return in dollars for every simulation scenario is placed on a continuum 413 which is a unit of +/−surplus such as dollars. A scenario that produces more cost than reserves is considered a negative surplus. Replications of two scenarios are depicted at distributions 416 and 420 and their accumulated frequencies at each surplus amount along the continuum 413 are ranked and integrated to produce a cumulative probability distribution for a set of design and operating control points. The combination of control points for the scenario depicted by distribution 416 are less likely to result in meeting the surplus constraint if said constraint was to be set at “break even” or $0. The probability (e.g., the risk) of achieving a return value of zero is determined by integrating the probability distribution function corresponding to distribution 416 and computing the probability at $0. In some instances, the automatically set control points related to the scenario depicted by distribution 420 dominate automatically set control points related to the scenario depicted by distribution 416 with respect to risk and return.

Referring back to FIG. 3, the DDSOA 100 uses the cash flow simulations to produce predictive profile data 308 associated with the power plant. The predictive profile data 308 provides information related to the viability of the decommissioning plan. Accordingly, the predictive profile data 308 includes probability distributions (e.g., probability distribution 412) representing the relationship between risk and return associated with the decommissioning plan. Further, the DDSOA 100 can use such probability distributions to determine whether the decommissioning plan will result in a threshold return value (e.g., zero return) and to determine the probability of such a result. The probability of the decommissioning data resulting in at least the threshold return value is also included in the predictive profile data 308. By default, the threshold return value may be zero, although in some embodiments, the threshold return value may be provided by a user (e.g., via an interface provided by the interface module 102) upon requesting simulation of the cash flows associated with a decommissioning plan.

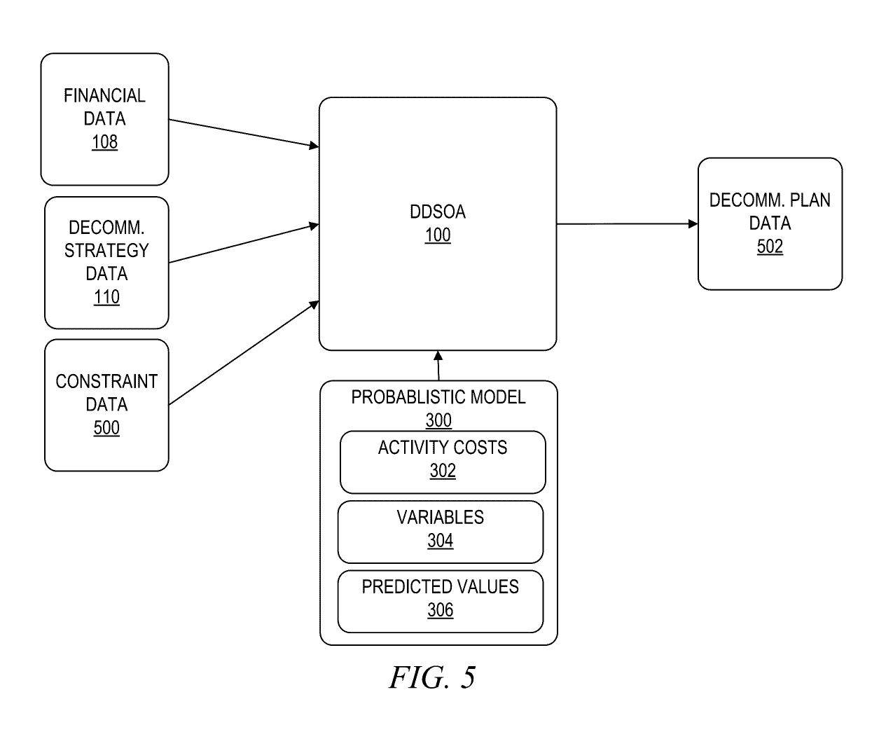

FIG. 5 is a data flow diagram illustrating a process for determining an optimal power plant decommissioning plan, according to some embodiments. As shown, the DDSOA 100 takes the financial data 108 (e.g., information regarding to funds maintained in one or more financial accounts maintained by one or more financial institutions), the decommissioning strategy data 112, and constraint data 500 as inputs. The decommissioning strategy data 112 includes a decision tree for corresponding to a decommissioning strategy (e.g., DECON, SAFSTOR, and ENTOMB) used to decommission a power plant. The particular decommissioning strategy employed, and thus, the decision tree included in the decommissioning strategy data 112 taken as an input, may be based on user selection from a drop-down menu or similar interface element. Each path in the decision tree corresponds to a possible decommissioning plan.

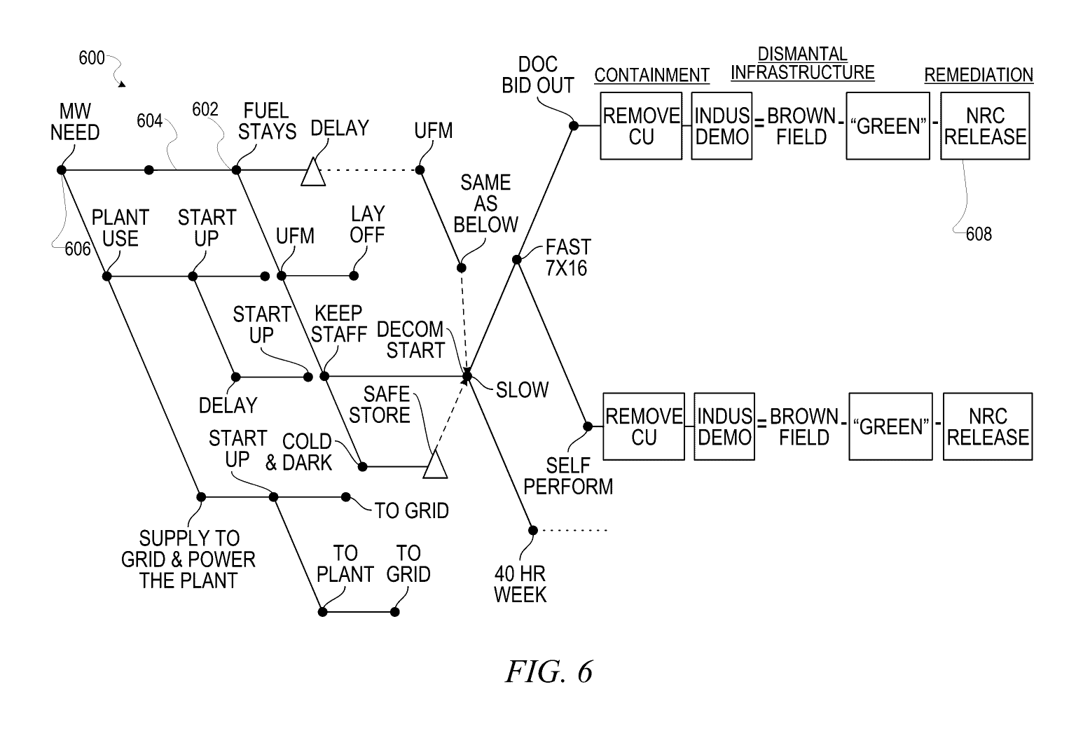

As an example, FIG. 6 is a diagram illustrating example decommissioning strategy data including a decision tree 600 representing possible power plant decommissioning plans, consistent with some embodiments. As shown, the decision tree 600 includes nodes (e.g., node 602) and branches (e.g., branch 604) connecting the nodes. Each node represents an activity, and each branch represents an outcome of an activity. At least a portion of the activities included in the decision tree 600 include activities. Certain activities include a decision that dictates the next activity, which results in the creation of several paths in the decision tree 600. Each path in the decision tree 600 connects a root node 606 to an end node (e.g., node 608). Each path in the decision tree 600 represents a possible decommissioning plan. It shall be appreciated that the text accompanying each node illustrated in the decision tree 600 is merely for illustrative purposes to provide examples of possible power plant activities.

Referring back to FIG. 5, the constraint data 500 includes one or more constraints related to determining an optimal decommissioning plan. The constraints may correspond to or be specified by power plant stakeholders such as regulators, local citizens, public utility commission, and power plant owners (e.g., shareholders). The constraints may be based on stakeholder preferences or applicable regulation (e.g., NRC regulations). The constraints may, for example, include a threshold risk value, a threshold return value, a start date for decommissioning or certain activities, a decommissioning end date, a decommissioning time horizon, or defined regulatory values for certain variables such as: inflation rate; investment growth rate; energy rate; energy production rate; labor costs; or equipment costs among others. Accordingly, in some instances, the constraints may constrain one or more of the variables 304 to a particular value (e.g., a particular date).

As shown, as part of the process of determining an optimal decommissioning plan, the DDSOA 100 accesses and employs the probabilistic model 300 to estimate a range of values corresponding to the return provided by each possible decommissioning plan represented by the decommissioning strategy data 112. More specifically, the DDSOA 100 iteratively simulates outcomes (e.g., cash flows and associated risks) of each decommissioning plan over the decommissioning time horizon using each value in the range of predicted values 306 for each variable in the plurality of variables 304. In this manner, the DDSOA 100 plays out every possible outcome of each possible decommissioning plan included in the decommissioning strategy data 112.

Based on the determined range of values corresponding to the return provided by each possible decommissioning plan, the DDSOA 100 generates decommissioning plan data 502 including schedule data corresponding to an optimal decommissioning plan. The decommissioning plan is optimal in terms of being the most favorable decommissioning plan in light of the constraints included in the constraint data 500. Accordingly, in generating the decommissioning plan data 502, the DDSOA 100 compares the various outcomes (e.g., in terms of risk and reward) of each possible decommissioning plan to identify the most favorable decommissioning plan that satisfies the constraints. As an example, if the constraints include a stakeholder risk preference (e.g., a threshold value for risk), the DDSOA 100 may select the decommissioning plan with the highest return from a subset of decommissioning plans have an associated risk value that does not exceed the stakeholder risk preference. The decommissioning plan data 502 includes a series of activities and an optimal date for undertaking each activity.

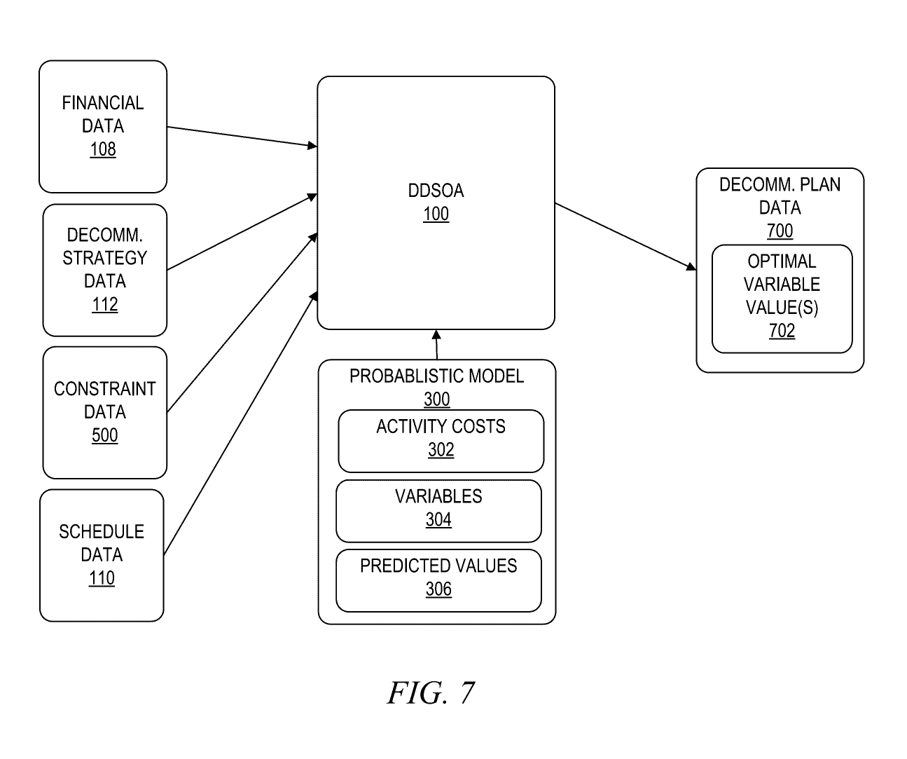

FIG. 7 is a data flow diagram illustrating a process for optimizing an existing power plant decommissioning plan, according to some embodiments. As shown, the DDSOA 100 takes, as inputs, the financial data 108 (e.g., information regarding funds maintained in one or more financial accounts maintained by one or more financial institutions), the decommissioning strategy data 112 (e.g., information related to each possible decommissioning plans for a particular decommissioning strategy), constraint data 500 including one or more constraints (e.g., a threshold risk value, a threshold return value, a start date for decommissioning or certain activities, a decommissioning end date, a decommissioning time horizon, or defined regulatory values), and schedule data 110 include an existing decommissioning plan. The DDSOA 100 then accesses and uses the probabilistic model 300 to simulate various outcomes (e.g., risks and returns) for each possible future path of the existing decommissioning plan as provided by the decision tree included in the decommissioning strategy data 112. Accordingly, the DDSOA 100 determines the current status of the existing decommissioning plan based on the schedule data 110, and identifies a corresponding node in the decommissioning strategy data 112.

In some instances, the constraint data 500 includes constraints that constrain one or more of the variables 304 to a particular value (e.g., a particular date). In the process of optimizing the existing decommissioning plan, the DDSOA 100 treats unconstrained variables—variables without a corresponding constraint—as flexible decision variables, and in doing so, the DDSOA 100 simulates future possible outcomes of the existing decommissioning strategy using a range of values for the flexible decision variables. The DDSOA 100 then analyses the outcomes to determine optimal variable value(s) 702 (e.g., dates) for the flexible decision variables (e.g., starting dates of specific activities) that result in outcomes that satisfy the constraints included in the constraint data 500. As an example, the DDSOA 100 may determine an optimal start date for a particular activity, or, as another example, the DDSOA 100 may determine an optimal time horizon for completing the activity. The DDSOA 100 then generates the decommissioning plan data 700 that includes updated schedule data corresponding to the optimized decommissioning plan with optimal variable value(s) 702. The decommissioning plan data 700 includes a series of activities, and depending on the outcome of the probabilistic analysis, the optimized decommissioning plan may include activities that are alternatives to the activities included in the schedule data 110.

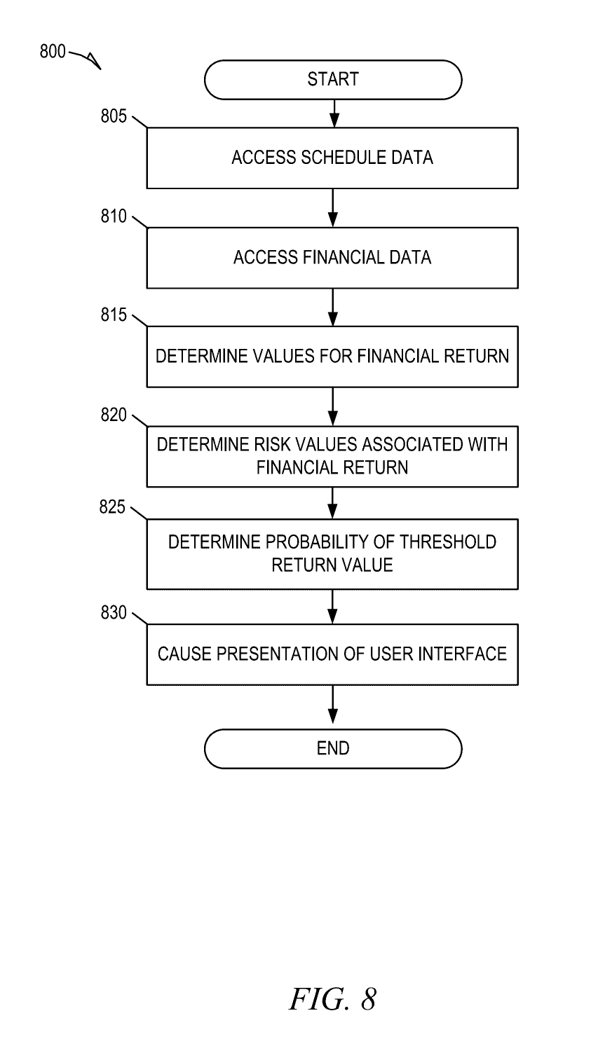

FIG. 8 is a flow chart illustrating a method 800 for determining viability of an existing power plant decommissioning plan, according to example embodiments. The method 800 may be embodied in computer-readable instructions for execution by a hardware component (e.g., a processor) such that the operations of the method 800 may be performed by the machine 200. In particular, the operations of the method 800 may be performed in part or in whole by the functional components forming the DDSOA 100 and, accordingly, the method 800 is described below, by way of example with reference thereto. However, it shall be appreciated that the method 800 may be deployed on various other hardware configurations and is not intended to be limited to the machine 200.

Consistent with some embodiments, the method 800 is initiated upon receiving a user request from a client device that includes a request for determining viability of an existing power plant decommissioning plan. At operation 805, the simulation module 104 accesses schedule data (e.g., schedule data 110) representing the existing decommissioning plan of a power plant. Accordingly, the schedule data includes a series of activities to be performed at the power plant. The schedule data further includes a decommissioning start date, a decommissioning time horizon, and a decommissioning end date. The schedule data may be received or retrieved by the interface module 102 from a client device in communication with the DDSOA 100, and stored in a computer-readable storage medium (e.g., a database) for subsequent retrieval by the simulation module 104.

At operation 810, the simulation module 104 accesses financial data (e.g., financial data 108) including an amount of funds associated with the power plant. For example, the financial data includes an amount of decommissioning funds set aside to decommission the power plant. The financial data may include funds from one or more financial accounts (e.g., savings account or brokerage account) maintained by one or more financial institutions (e.g., banks). The financial data may be accessed directly from a computing system corresponding to a financial institution, or the financial data may be retrieved from such a computing system or a client device, and stored in a computer-readable storage medium (e.g., a database) for subsequent retrieval by the simulation module 104.

At operation 815, the simulation module 104 determines, using a probabilistic model, a range of values corresponding to a return (e.g., an economic return in terms of dollars) associated with the decommissioning plan. The simulation module 104 determines the range of values by calculating an aggregate of investment return values, operational cash flow values (e.g., an aggregate of operational cost values and operational revenue values), and cost values associated with each activity in the decommissioning plan.

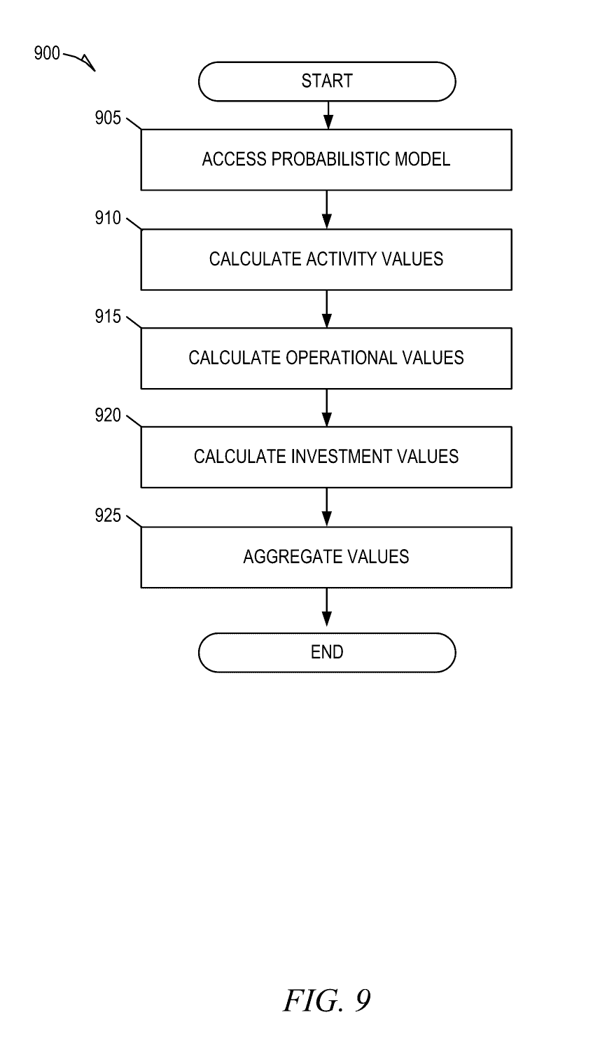

As a detailed example of the process involved in the foregoing operation, FIG. 9 is a flow chart illustrating a method 900 for determining a return associated with a power plant decommissioning plan, according to example embodiments. The method 900 may be embodied in computer-readable instructions for execution by a hardware component (e.g., a processor) such that the operations of the method 900 may be performed by the machine 200. In particular, the operations of the method 900 may be performed in part or in whole by the simulation module 104 of the DDSOA 100 and, accordingly, the method 900 is described below, by way of example with reference thereto. However, it shall be appreciated that the method 900 may be deployed on various other hardware configurations and is not intended to be limited to the machine 200.

At operation 905, the simulation module 104 accesses probabilistic model data including a probabilistic model used to simulate cash flow values of the power plant using historical and regulatory values as a basis. The probabilistic model includes a plurality of variables used to calculate cash flow values (e.g., inflation rate, investment growth rate (e.g., interest rate), energy rate, and energy production rate), and a range of predicted values for the variables. The probabilistic model further includes predicted cost values associated with each activity in the decommissioning plan.

At operation 910, the simulation module 104 calculates values corresponding to costs associated with each activity in the decommissioning plan (referred to herein as “activity values”). As an example, the simulation module 104 calculates the activity values using the activity costs 302, variables 304, and the predicted values 306 included in the probabilistic model 300. More specifically, the simulation module 104 calculates net present values (NPV) corresponding to each activity using the respective costs of the activity included in the activity costs 302 and the range of values for inflation rate included in the range of predicted values 306.

At operation 915, the simulation module 104 calculates values corresponding to cash flows associated with the power plant operation (referred to herein as “operational values”) over the decommissioning time horizon. The simulation module 104 calculates the operational values using the variables 304 and the range of predicted values 306 included in the probabilistic model 300. For example, the simulation module 104 calculates NPVs of operational revenues using the range of predicted values 306 for each of the variables associated with inflation rate, energy rate, and energy production rate. The simulation module 104 also calculates NPVs of operational costs using the range of predicted values 306 for each of the variables associated with inflation rate, labor costs, and maintenance costs. The simulation module 104 then determines the operational values based on an aggregate of the NPVs of operational revenues and the NPVs of operational costs.

At operation 920, the simulation module 104 calculates values corresponding to investment return (referred to herein as “investment values”) associated with the power plant over the decommissioning time horizon. The simulation module 104 calculates the investment return based on the amount of funds included in the financial data 108, and using the variables 304 and the range of predicted values 306 included in the probabilistic model 300. More specifically, the simulation module 104 determines the investment values using the range of predicted values 306 corresponding to investment growth rate.

At operation 925, the simulation module 104 aggregates the activity values, operational values, and investment values to produce the range of values corresponding to a return associated with the decommissioning plan. For example, the simulation module 104 may, for each possible variable value in the probabilistic model, determine the sum of activity values, operational value, and investment value, thus producing a return value for each possible variable value.

Referring back to FIG. 8, at operation 820, the simulation module 104 determines risk values (e.g., corresponding to economic risk) associated with the range of values corresponding to the return associated with the decommissioning plan. The simulation module 104 may, for example, determine the risk values by calculating a variance of the range of values corresponding to the return associated with the decommissioning plan.

At operation 825, the simulation module 104 determines a probability of the power plant decommissioning plan resulting in at least a threshold return value. By default, the threshold return value may be zero, although in some embodiments, the threshold return value may be provided by a user (e.g., via an interface provided by the interface module 102) upon requesting simulation of the cash flows associated with a decommissioning plan. For example, consistent with some embodiments, the method 800 is initiated upon receiving a user request from a client device, and in some instances, the threshold return value is included in the request.

At operation 830, the interface module 102 causes presentation of a user interface on a client device. For example, the interface module 102 may provide the client device with a set of computer-readable instructions that, when executed by the client device, cause the client device to display the user interface. The client device on which the user interface is displayed may be the client device from which the user request that caused the initiation of method 800 was received. The user interface includes a display of the probability of the power plant decommissioning plan resulting in at least a threshold return value. The probability of the power plant decommissioning plan resulting in at least the threshold return value provides stakeholders with an indicator of the viability of the decommissioning plan. For example, in instances in which the threshold return value is zero, the probability of the power plant decommissioning plan resulting in zero return indicates whether the amount of decommissioning funds set aside to decommission the power plant is actually sufficient to do so.

Consistent with some embodiments, the user interface may also include a graphical representation of a relationship between the determined range of values corresponding to the return associated with the decommissioning plan, and the risk values associated with the range of values. For example, the user interface may include a probability distribution graph of return values associated with the decommissioning plan. The probability distribution graph provides an indication of the probabilities associated with each possible return associated with the power plant decommissioning plan.

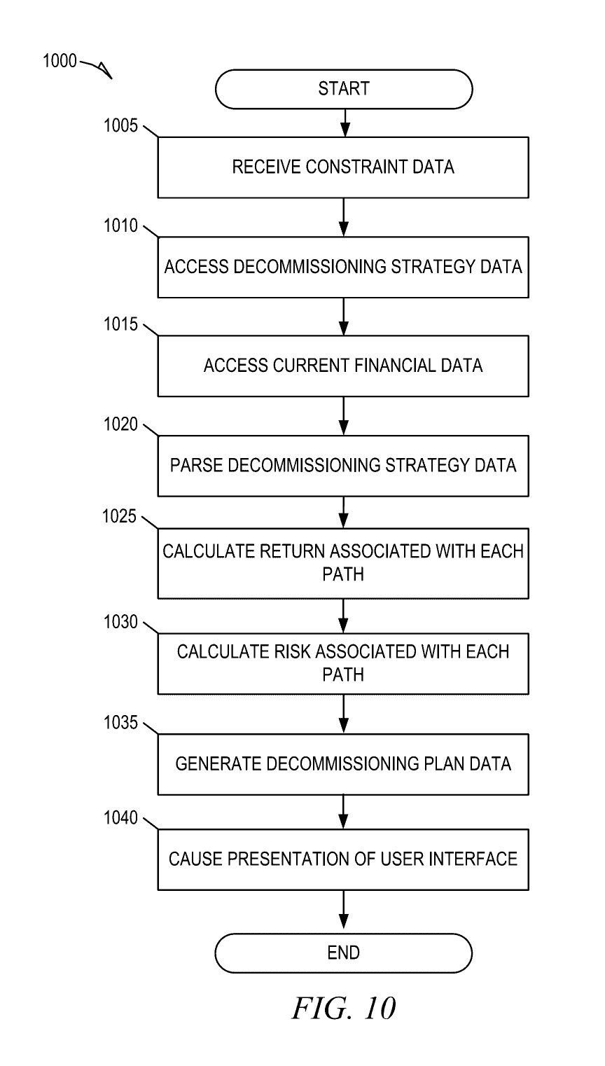

FIG. 10 is a flow chart illustrating a method 1000 for determining an optimal power plant decommissioning plan based on stakeholder constraints, according to example embodiments. The method 1000 may be embodied in computer-readable instructions for execution by a hardware component (e.g., a processor) such that the operations of the method 1000 may be performed by the machine 200. In particular, the operations of the method 1000 may be performed in part or in whole by the DDSOA 100 and, accordingly, the method 1000 is described below, by way of example with reference thereto. However, it shall be appreciated that the method 1000 may be deployed on various other hardware configurations and is not intended to be limited to the machine 200.

At operation 1005, the interface module 102 receives constraint data including one or more constraints for determining an optimal power plant decommissioning plan. The constraint data may, for example, be included in a user request (e.g., received by the interface module 102 from a client device) for an optimal power plant decommissioning plan. The user request may also specify a particular decommissioning strategy for decommissioning the power plant. The one or more constraints may relate to preferences or operational requirements of stakeholder (e.g., regulators, local citizens, public utility commission, and power plant owners). The constraint data may include one or more constraints that constrain variables (e.g., dates) used in simulating cash flows of the power plant to a particular value (e.g., a particular date). Accordingly, the one or more constraints may, for example, include a specific start date for decommissioning, a start date for a particular activity, an end date for decommissioning, a time period for decommissioning, a threshold value for risk (e.g., a risk preference), or a threshold value for return (e.g., a return preference).

At operation 1010, the simulation module 104 accesses decommissioning strategy data corresponding to the decommissioning strategy specified in the user request. The decommissioning strategy data includes information related to possible decommissioning plans for the decommissioning strategy. In particular, the decommissioning strategy data includes a decision tree representing each possible decommissioning plan. More specifically, each path in the decision tree of the decommissioning strategy data corresponds to a possible decommissioning plan. At operation 1015, the simulation module 104 parses the decommissioning strategy data to identify each possible decommissioning plan represented by the decision tree

At operation 1020, the simulation module 104 accesses financial data including an amount of funds associated with the power plant (e.g., an amount of decommissioning funds set aside to decommission the power plant). The financial data may include funds from one or more financial accounts (e.g., savings account or brokerage account) maintained by one or more financial institutions (e.g., banks).

At operation 1025, the simulation module 104 determines, using a probabilistic model, a range of values corresponding to a return (e.g., an economic return in terms of dollars) associated with each possible decommissioning plan in the decision tree. The simulation module 104 determines the range of values by calculating an aggregate of investment return values, operational cash flow values (e.g., an aggregate of operational cost values and operational revenue values), and cost values associated with each activity in each possible decommissioning plan. Consistent with some embodiments, the operation 1025 includes iteratively performing the method 900 for each possible decommissioning plan in the decision tree.

At operation 1030, the simulation module 104 determines, for each path in the decision tree, risk values (e.g., corresponding to economic risk) associated with the range of values corresponding to the return associated with respective possible decommissioning plans. The simulation module 104 may, for example, determine the risk values by calculating a variance of the range of values corresponding to the return associated with each possible decommissioning plan.

At operation 1035, the optimization module 106 generates decommissioning plan data based on the return values and the risk values associated with each path in the decision tree. The decommissioning plan data includes schedule data representing the requested optimal decommissioning plan. The optimal decommissioning plan is the most favorable of the possible decommissioning plans (e.g., in terms of return) in the decommissioning strategy data that satisfies the one or more constraints in the user request. The decommissioning plan data includes a series of activities along with identifier of each activity, a scheduled date for the activity, and a duration activity.

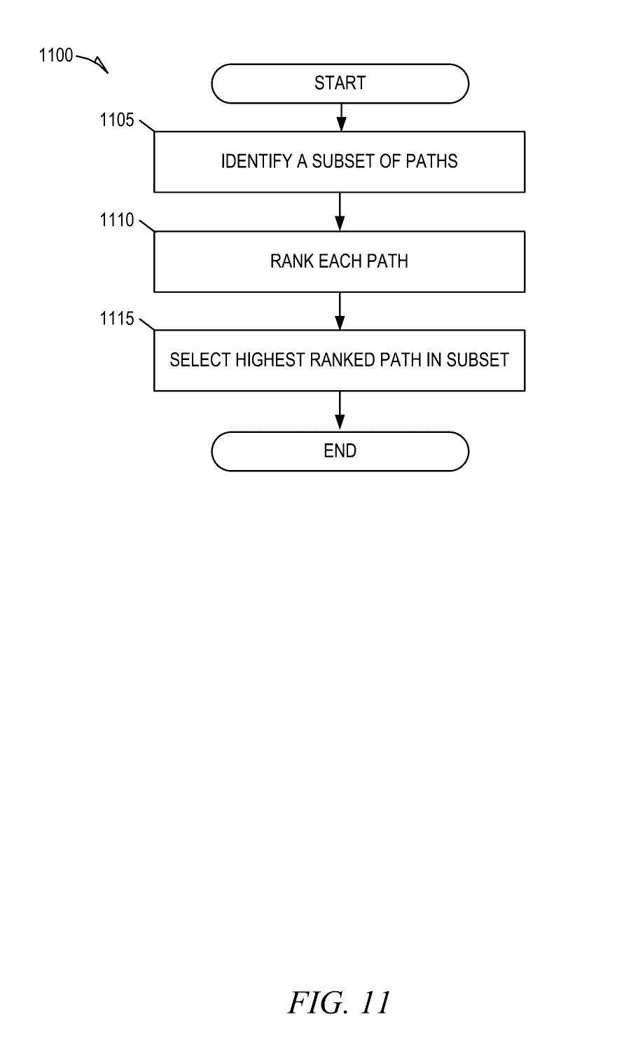

As a detailed example of the process involved in the foregoing operation, FIG. 11 is a flow chart illustrating a method 1100 for selecting an optimal path in a decision tree representing a plurality of decommissioning plans, according to an example embodiment. The method 1100 may be embodied in computer-readable instructions for execution by a hardware component (e.g., a processor) such that the operations of the method 1100 may be performed by the machine 200. In particular, the operations of the method 1100 may be performed in part or in whole by the optimization module 106 of the DDSOA 100 and, accordingly, the method 1100 is described below, by way of example with reference thereto. However, it shall be appreciated that the method 1100 may be deployed on various other hardware configurations and is not intended to be limited to the machine 200.

At operation 1105, the optimization module 106 identifies a subset of the paths (e.g., a subset of possible decommissioning plans) included in the decision tree that satisfy the one or more constraints. At operation 1110, the optimization module 106 ranks each path included in the subset of paths identified at operation 1105.

As an example of the foregoing operations, if the one or more constraints include a threshold risk value (e.g., a risk preference), at operation 1105, the optimization module 106 identifies a subset of paths in the decision tree that have an associated risk value that does not exceed the threshold risk value. Following this example, at operation 1110, the optimization module 106 ranks each path included in the subset of paths based on the respective return associated with each path.

As another example of the foregoing operations, if the one or more constraints include a threshold return value (e.g., a return preference), at operation 1105, the optimization module 106 identifies a subset of paths in the decision tree that have an associated return value that does not exceed the threshold return value. Following this example, at operation 1110, the optimization module 106 ranks each path included in the subset of paths based on the respective risk associated with each path.

At operation 1115, the optimization module 106 selects the highest ranked path (e.g., the highest ranked possible decommissioning plan) in the subset of paths as the optimal decommissioning plan. For example, the optimization module 106 may select the path with the highest return value that satisfies a stakeholder risk preference included in the one or more constraints included in the request.

Referring back to FIG. 10, at operation 1040, the interface module 102 causes presentation of a user interface on a client device. For example, the interface module 102 may provide the client device with a set of computer-readable instructions that, when executed by the client device, causes the client device to display the user interface. The client device on which the user interface is displayed may be the client device from which the user request was received. The user interface includes a graphical representation of the decommissioning plan data. In some embodiments, the user interface includes a graphical representation of the decision tree with the path corresponding to the optimal decommissioning plan being visually distinguished from the remainder of the paths in the decision tree. The user interface may further include an indicator of the rank of each path in the decision tree. In some embodiments, the user interface includes a textual list of the activities involved in the optimal decommissioning plan along with the identifier of the activity, a scheduled date for the activity, and a duration of the activity. In some embodiments, the user interface includes an element (e.g., a button) that allows users to toggle between the graphical representation of the decision tree and textual list of the activities involved in the optimal decommissioning plan.

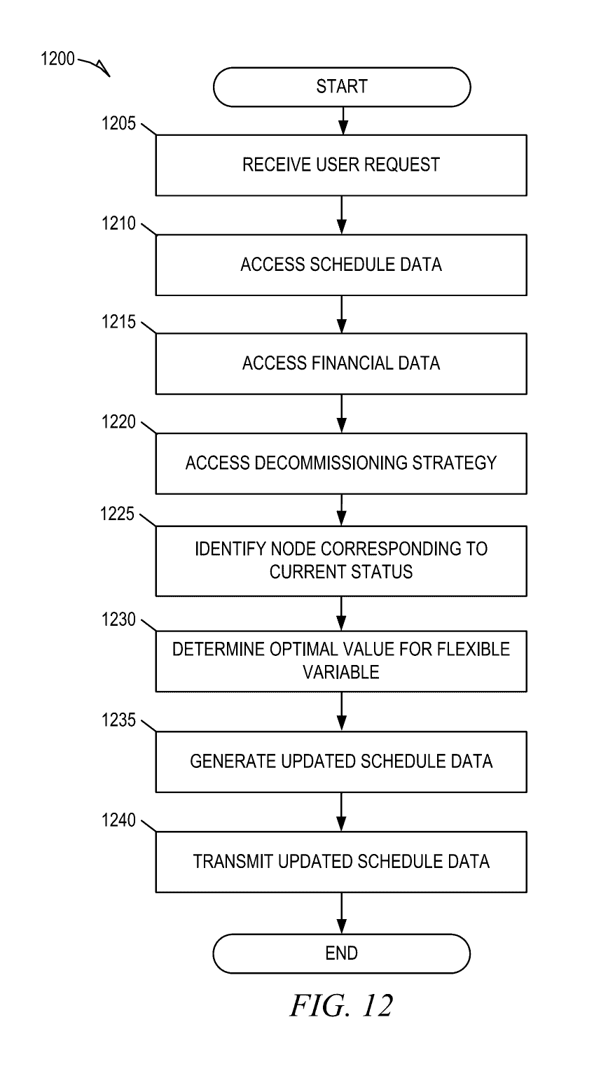

FIG. 12 is a flow chart illustrating a method 1200 for optimizing an existing decommissioning plan, according to an example embodiment. The method 1200 may be embodied in computer-readable instructions for execution by a hardware component (e.g., a processor) such that the operations of the method 1200 may be performed by the machine 200. In particular, the operations of the method 1200 may be performed in part or in whole by the DDSOA 100 and, accordingly, the method 1200 is described below, by way of example with reference thereto. However, it shall be appreciated that the method 1200 may be deployed on various other hardware configurations and is not intended to be limited to the machine 200.

At operation 1205, the interface module 102 receives, from a client device, a user request to optimize an existing power plant decommissioning plan. The user request includes constraint data including one or more constraints for optimizing the power plant decommissioning plan. The one or more constraints may relate to preferences or operational requirements of stakeholders (e.g., regulators, local citizens, public utility commission, and power plant owners). The one or more constraints may, for example, include at least one of a threshold value for risk (e.g., a risk preference), a threshold value for return (e.g., a return preference), a specific start date for decommissioning, a start date for a particular activity, an end date for decommissioning, or a time period for decommissioning. Accordingly, in some instances, the one or more constraints may constrain one or more variables (e.g., dates) used in optimizing a power plant decommissioning plan to a particular value (e.g., a particular date).

In some embodiments, the user request also specifies a flexible decision variable to be optimized in accordance with the one or more constraints. In some embodiments, the optimization module 106 may treat as a flexible decision variable any factor that impacts the outcome of the existing decommissioning plan without a corresponding constraint. The flexible decision variable may, for example, include an amount of funds to set aside for decommissioning, a specific start date for decommissioning, a start date for a particular activity, an end date for decommissioning, or a time period for decommissioning.

At operation 1210, the simulation module 104 accesses schedule data (e.g., schedule data 110) representing the existing decommissioning plan of a power plant. The schedule data includes a series of activities to be performed at the power plant. The schedule data may be received by the interface module 102 as part of the user request received form the client device, or the simulation module 104 may access stored schedule data corresponding to the power plant. At operation 1215, the simulation module 104 accesses financial data (e.g., financial data 108) including an amount of funds associated with the power plant (e.g., an amount of decommissioning funds set aside to decommission the power plant maintained in one or more financial accounts).

At operation 1220, the simulation module 104 accesses decommissioning strategy data (e.g., decommissioning strategy data 112) corresponding to the existing decommissioning plan. The decommissioning strategy data includes a decision tree representing each possible decommissioning plan of the decommissioning strategy corresponding to the existing decommissioning plan.

At operation 1225, the simulation module 104 identifies a node in the decision tree of the decommissioning strategy data that corresponds to the current status of the existing decommissioning plan. The identification of the node includes determining a current status of the decommissioning plan based on the schedule data and the current date, determining an identifier corresponding to the current status, and using the identifier to locate the corresponding node in the decision tree.

At operation 1230, the optimization module 106 determines, using a probabilistic model, an optimal value for the flexible decision variable based on the one or more constraints. In determining the optimal value for the flexible decision variable, the optimization module 106 works in conjunction with the simulation module 104 to simulate outcomes of each possible forward path in the decision tree using varying values for the flexible decision variable. Possible forward paths include each path in the decision tree originating from the node corresponding to the current status of the decommissioning plan and terminating at an end node.

The simulation module 104 may simulate the outcomes of each possible forward path in the decision tree by iteratively performing the method 900 for each forward path using varying values for the flexible decision variable, which in some embodiments may correspond to a variable included in the probabilistic model 300. As an example, the simulation module 104 may simulate the outcomes of each possible forward path for different decommissioning end dates to determine the favorable end date that results in an outcome (e.g., a return) that satisfies the one or more constraints. As another example, the simulation module 104 may simulate outcomes of each possible forward path for different start dates of a particular activity to determine the most favorable start date for the activity that results in an outcome (e.g., a return) that satisfies the one or more constraints.

At operation 1235, the optimization module 106 uses the optimal value for the flexible decision variable to generate updated schedule data based on the existing schedule data. The updated schedule data includes the existing decommissioning plan optimized with the optimal value (e.g., a date) for the flexible decision variable (e.g., starting date for a particular activity).

At operation 1240, the interface module 102 transmits the updated schedule data to the requesting client device for deployment at the power plant. In some embodiments, the interface module 102 may further cause presentation of a user interface on the requesting client device for presenting the updated schedule data.

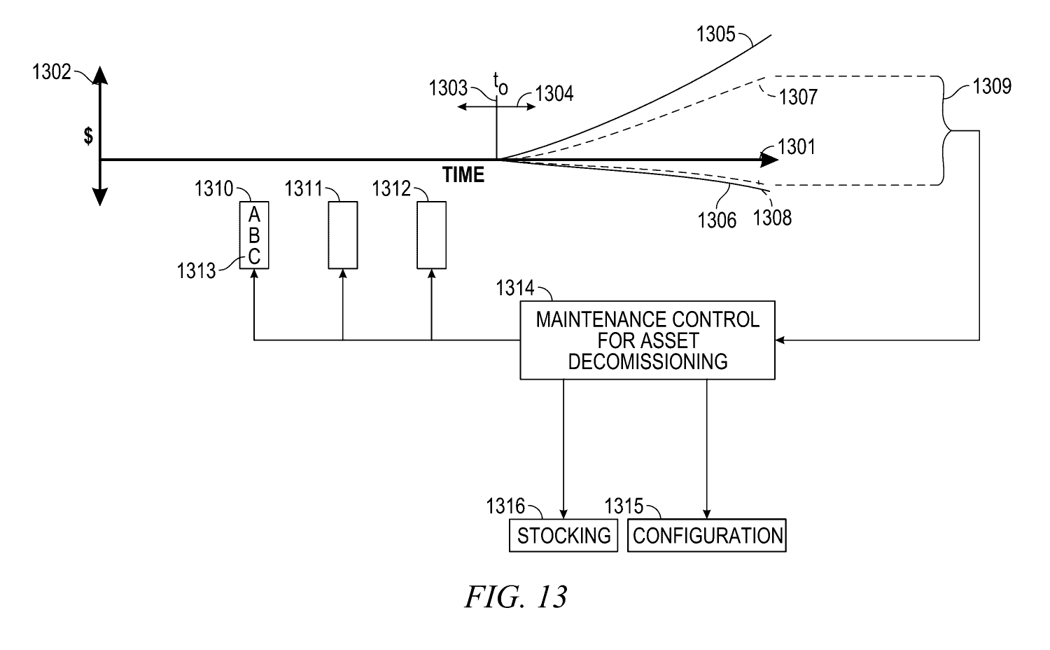

In some embodiments, an ability to reconcile constraints related to decommissioning through the active control of one or more maintenance work scopes ahead of the decommissioning event is provided so as to enable the cost and timing for the decommissioning sequence to meet set points. As an example of the foregoing, FIG. 13 is a graph illustrating a process of automatically reconciling decommissioning timing and cost constraints with dynamical control of prior outage work scopes, according to example embodiments. As shown, time 1301 begins at a point ahead of the triggering event 1303 for the decommissioning. The triggering event 1303 is set by other aspects of the disclosed invention to occur optimally within a time interval 1304. One or more decommissioning scenarios result in one or more ranges of cost over the decommissioning period. An uncontrolled pre-decommissioning sequence of maintenance and operations constraints results in a first cost range between 1305 and 1306. A beneficial control of one or more maintenance work scopes or operations ahead of the triggering event 1303 result in a second cost range between 1307 and 1308. Lower cost may be an objective and may also, optionally, be a constraint. The constrained cost range 1309, which may be set some embodiments of this invention by the lifecycle economic limits of the power plant operation and its decommissioning reserves, is used by the maintenance control for asset decommissioning 1314 to dynamically adjust the work scopes of outages and, optionally, the plant operations that give rise to the need for certain of the work scopes. The sequence of work scopes may be one or more, a first outage 1310 farthest away from the triggering event 1303, a second outage 1311 and third outage 1312. In an outage there may be certified work scopes 1313 that are automatically adjusted by the maintenance control 1314 which is a goal seeking optimizer using one or more of linear, mixed integer, non-linear, heuristic methods to select work scopes. The control 1314 may optionally change the physical design of decommissioning apparatus and may optionally control the stocking levels of specialized assets such as nuclear fuel, parts, and consumables. A work scope, timing 1310, 1311, and 1312, decommissioning apparatus design 1315, and specialized stocking 1316 may be jointly optimized to reconcile a constraint such as cost, for example.

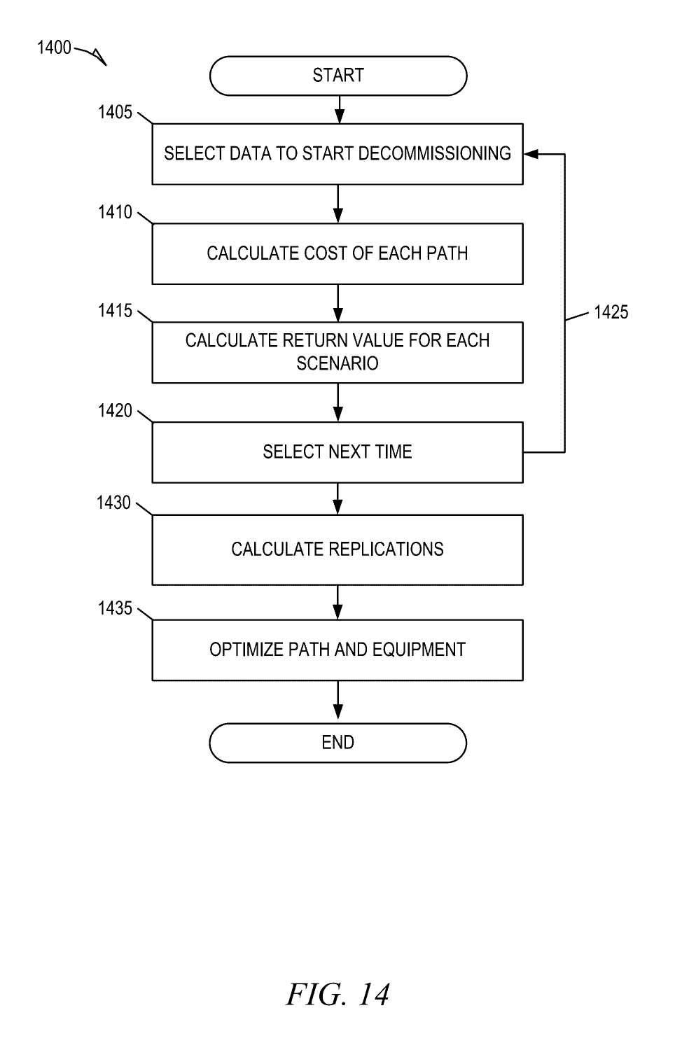

In some embodiments, risk reduction in the dismantlement process of decommissioning is a criteria used in automatically reconciling the decommissioning method, timing, equipment design selection, and work scope for an event with respect to the optimized decommissioning date and for the prosecution of the plant's dismantlement. That is, it may be preferred that the dismantlement occur at a lower cost and risk. As an example of the foregoing, FIG. 14 is a flow chart illustrating a method 1400 for determining an optimal power plant decommissioning plan based on stakeholder constraints, according to some example embodiments. The method 1400 may be embodied in computer-readable instructions for execution by a hardware component (e.g., a processor) such that the operations of the method 1400 may be performed by the machine 200. In particular, the operations of the method 1400 may be performed in part or in whole by the DDSOA 100 and, accordingly, the method 1400 is described below, by way of example with reference thereto. However, it shall be appreciated that the method 1200 may be deployed on various other hardware configurations and is not intended to be limited to the machine 200.

In the simulation of the plant's lifecycle economic life, the start of a decommissioning scenario (e.g., node 602) is selected at operation 1405. At operation 1410, costs are calculated for labor, consumables, materials and other such expenses as are required for a given scenario for each activity on the chosen decommissioning path. A given scenario's expense timing is combined with the reserve level at the simulated future time points and, at operation 1415, a net present value is calculated for each of the scenario paths and stored as a vector of time, reserves, activities, expenses, NPV. At operation 1420, the next time interval is selected. At operation 1420, the method 1400 may return to operation 1405 and the process is repeated until such time as the future activities and the NPV of the plant's economic life is fully enumerated.

Exogenous forces such as interest rates for the reserves investment returns, new constraints such as regulatory measures or escalations of disposal fees may necessitate calculating replications, at operation 1430, that are made of the full enumeration of paths in the decommissioning tree structure (e.g., decision tree 600). The activities most contributing to the negative variation of NPV are risk drivers. In some embodiments, a threshold level of risk is set as a constraint to which the design of the decommissioning timing and apparatus used along with the requisite labor and consumables for said design is achieved by changing or reconciling the type of engineering design and sizing of apparatus so as to reduce the labor and materials cost and/or duration of time so as to maximize the total economic lifecycle value, at operation 1435.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field-programmable gate array (FPGA) or an ASIC) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses that connect the hardware modules). In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, or software, or in combinations of them. Example embodiments may be implemented using a computer program product, for example, a computer program tangibly embodied in an information carrier, for example, in a machine-readable medium for execution by, or to control the operation of, data processing apparatus, for example, a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site, or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., an FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

### Language

Although the embodiments of the present invention have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent, to those of skill in the art, upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated references should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim.

What is claimed is:

1. A method comprising:
receiving constraint data comprising one or more constraints for determining a power plant decommissioning plan;
accessing decommissioning strategy data, the decommissioning strategy data including a decision tree, the decision tree including nodes representing activities associated with decommissioning a power plant;
parsing the decommissioning strategy data to identify a plurality of paths in the decision tree, each path of the plurality of paths representing a possible power plant decommissioning plan;
generating, using one or more processors, decommissioning plan data in accordance with the constraint data based on the decommissioning strategy data, the decommissioning plan data including the power plant decommissioning plan, the power plant decommissioning plan corresponding to a path selected from the plurality of paths of the decision tree; and
causing presentation of a user interface on a client device, the user interface including a graphical representation of the power plant decommissioning plan.

2. The method of claim 1, further comprising calculating a range of return values associated with each path in the plurality of paths of the decision tree, wherein the path selected from the plurality of paths in the decision tree is selected based on the range of return vales associated with the path.

3. The method of claim 2, wherein the calculating of the range of return values associated with each path in the decision tree includes:
calculating a set of activity values, the set of activity values corresponding to costs associated with each activity in the path;
calculating a set of operational values, the set of operational values corresponding to cash flows associated with operating the power plant;
calculating a set of investment values, the set of investment values corresponding to investment returns associated with the power plant; and
aggregating the set of activity values, the set of operational values, and the set of investment values to determine the range of return values.

4. The method of claim 3, further comprising accessing a probabilistic model including a plurality of variables and a predicted range of values for each variable in the plurality of variables, wherein the plurality of variables and the predicted range of values are used in calculating the set of activity values, the set of operational values, and the set of investment values.

5. The method of claim 3, wherein the calculating of the set of investment values is based on financial data obtained, via network, from a computer system corresponding to a financial institution.

6. The method of claim 4, wherein the plurality of variables includes at least one of an inflation rate, an investment growth rate, an energy rate, an energy production rate, and activity cost values.

7. The method of claim 1, further comprising calculating a risk value associated with each path in the plurality of paths of the decision tree, wherein the path selected from the plurality of paths in the decision tree is selected based on the risk value associated with the path.

8. The method of claim 1, wherein the generating of the decommissioning plan data includes:
identifying a subset of paths from the plurality of paths that satisfy the one or more constraints;
ranking each path in the subset of paths; and
selecting the path from the subset of paths based on the ranking of the path.

9. The method of claim 8, wherein the user interface includes a graphical representation of the decision tree, the graphical representation of the decision tree including the ranking of each path.

10. The method of claim 8,
wherein the constraint data includes a threshold risk value;
wherein the identifying the subset of paths includes determining the subset of paths include an associated risk value below the threshold risk value;
wherein the ranking of each path in the subset of paths is based on a return associated with each path; and
wherein the selecting of the path is based on the return associated with the path.

11. The method of claim 1, wherein the one or more constraints include at least one of a threshold risk value, a threshold return value, a decommissioning start date, a start date for a certain activity, a decommissioning end date, or a decommissioning time horizon.

12. A system comprising:
a machine-readable medium to store decommissioning strategy data, the decommissioning strategy data including a decision tree, the decision tree including a plurality of nodes, each node in the plurality of nodes corresponding to an activity associated with decommissioning a power plant, each path in the decision tree representing a possible power plant decommissioning plan;
an interface module to receive constraint data comprising one or more constraints for determining a power plant decommissioning plan;
an optimization module, comprising one or more processors, to generate decommissioning plan data based on the decommissioning strategy data in accordance with the constraint data, the decommissioning plan data including the requested power plant decommissioning plan, the power plant decommissioning plan corresponding to a path selected from a plurality of paths of the decision tree; and
the user interface module further to cause presentation of a user interface on a client device, the user interface including a graphical representation of the power plant decommissioning plan.

13. The system of claim 12, further comprising a simulation module to:
calculate a range of return values associated with each path in the plurality of paths of the decision tree; and
calculate a risk associated with each path based on the range of return values associated with each path;
wherein the path selected from the plurality of paths in the decision tree is selected based on the range of return values and the risk associated with the path.

14. The system of claim 13, wherein the simulation module is to calculate the range of return values associated with each path by performing operations comprising:
calculating a set of activity values, the set of activity values corresponding to costs associated with each activity in the path;
calculating a set of operational values, the set of operational values corresponding to cash flows associated with operating the power plant;
calculating a set of investment values, the set of investment values corresponding to investment returns associated with the power plant; and
aggregating the set of activity values, the set of operational values, and the set of investment values to determine the range of return values.

15. The system of claim 14, wherein the operations further comprise accessing a probabilistic model including a plurality of variables and a predicted range of values for each variable in the plurality of variables, wherein the plurality of variables and the predicted range of values are used in calculating the set of activity values, the set of operational values, and the set of investment values.

16. The system of claim 15, wherein the plurality of variables includes at least one of an inflation rate, an investment growth rate, an energy rate, an energy production rate, and activity cost values.

17. The system of claim 12, wherein the optimization module is to generate the decommissioning plan data by performing operations comprising:
identifying a subset of paths from the plurality of paths that satisfy the one or more constraints;
ranking each path in the subset of paths; and
selecting the path from the subset of paths based on the ranking of the path.

18. The system of claim 12, wherein the one or more constraints include at least one of a threshold risk value, a threshold return value, a decommissioning start date, a start date for a certain activity, a decommissioning end date, or a decommissioning time horizon.

19. The system of claim 12, wherein the graphical representation of the optimal decommissioning plan includes a graphical representation of the decision tree, wherein the path corresponding to the decommissioning plan is visually distinguished from the remainder of paths in the decision tree.

20. A non-transitory machine-readable storage medium embodying instructions that, when executed by at least one processor of a machine, cause the machine to perform operations comprising:
receiving constraint data comprising one or more constraints for determining a power plant decommissioning plan;
accessing decommissioning strategy data, the decommissioning strategy data including a decision tree, the decision tree including nodes representing activities associated with decommissioning a power plant;
parsing the decommissioning strategy data to identify a plurality of paths in the decision tree, each path of the plurality of paths representing a possible power plant decommissioning plan;
generating, using one or more processors, decommissioning plan data based on the decommissioning strategy data in accordance with the constraint data, the decommissioning plan data including the requested power plant decommissioning plan, the power plant decommissioning plan corresponding to a path selected from the plurality of paths of the decision tree; and
causing presentation of a user interface on a client device, the user interface including a graphical representation of the power plant decommissioning plan.
